(19) United States
(12) Patent Application Publication
(10) Pub. No.: US 2011/0089702 A1
(43) Pub. Date: Apr. 21, 2011

(54) FLUIDKINETIC ENERGY CONVERTER

(76) Inventors: David Boren, Boise, ID (US); Jonathan Boren, Boise, ID (US); Dwayne Kreipl, Boise, ID (US)

(21) Appl. No.: 12/977,014

(22) Filed: Dec. 22, 2010

(51) Int. Cl. F03D 9/00; F01D 25/24

(52) U.S. Cl. 290/55; 415/182.1

(57) ABSTRACT

A fluidkinetic energy converter includes a passageway-filled enclosure. Turbines are mounted in the passageways and fluid flow may be concentrated on subparts of the turbines by inner fluid flow deflectors or dividers. The energy converter enclosure can include dividers at both inlets and outlets in order to be adaptable for either river or tidal environments. Notably, apart from the turbines and energy generating components, the enclosure may be implemented such as to have no moving parts, thereby reducing complexity, cost, and weight.

### BACKGROUND

The present application relates generally to the field of fluid-based energy conversion and more specifically to fluidkinetic energy conversion in both uni- and bi-directional currents.

Historically, conventional methods of converting water flow into useable energy have been done through large dams and systems of generators. While the electricity generated from these sources is reliable, altering the natural flow of rivers has an extremely negative impact on the environment. Although devices have been used in converting flowing water into useable energy for centuries, there has been a recent push for more environmentally friendly solutions to produce power and provide energy. Much progress has been made in recent years improving upon designs that convert kinetic energy from tides and rivers into an energy source available to the public.

These fluidkinetic devices have significant advantages over solar and wind powered devices. Tides and rivers offer a much more reliable, predictable and consistent source of renewable energy, if captured correctly. Previous designs and proposals are far from ideal. Many tide conversion systems involve extreme environmental alterations. For example, the earliest tidal power station, the Rance Tidal Power Station, involves a half mile dam on the estuary restricting the natural flow of ocean and requiring a nine square mile tidal basin.

Most fluidkinetic designs are also extremely complex and are expensive to build, transport, install, and maintain. The Francis turbine, for instance, is one of the most widely used designs in the world. However, its impressive efficiency comes from a rather complex design that includes moving turbine blades. Obviously, as moving parts are added, fluidkinetic energy conversion designs quickly become more complex and more expensive.

Efforts have recently been made to provide devices that are able to efficiently extract electricity from the kinetic energy of naturally flowing bodies of water. These designs have allowed for smaller scale production and opened the possibility for many previously uneconomical generation sites. Many of these models are optimized for rivers and other inland water energy extraction, making them inefficient and/or unsuitable for use in tides.

Designing a device that will work well in the ocean poses several unique challenges. Unlike inland energy capturing devices, an efficient and effective tidal device requires a bi-directional design of either the turbines, the generating system, or a combination of both.

Several innovations have been made to allow for the capture of both the inbound and ebb flow of ocean tides. For example there have been designs where a conventional hydro turbine is mounted on a pivot on the floor of the ocean, or some other stationary object. Devices such as this are periodically rotated 180 degrees to face the changing direction of the current. While these types of devices are able to capture the majority of available flow, they are not yet commercially practical. Devices with more moving parts require more maintenance and will cost more to manufacture and operate than simple fixed devices.

Therefore a need exists for a simple, reliable, economical solution for extracting kinetic energy from flowing bodies of water. The present invention provides a simple and cost-effective device for converting fluidkinetic energy into useable energy, such as electricity.

### SUMMARY

One embodiment of the present invention described below includes two turbines rotating in opposite directions and places them substantially in series in the same housing or enclosure. As shown, the turbines are offset, having one turbine positioned towards one end of the enclosure and one towards the opposite end. The enclosure inlets may include a fluid flow divider unit, or divider, which concentrates the fluid entering the device into two parallel passageways, each of which may have a width of approximately one third of the total width of the device. The divider unit may be connected to an internal wall which isolates the passageways. A number of configurations are possible for the divider. For example, in one embodiment, immediately in advance of the rear turbine, the internal wall may angle to the right to make room for the rear turbine. The wall may then continue and connect to the divider unit at the other end of the device. One advantage of some embodiments is that, because of the simplicity of the design, the rear half of the device may be a mirror image of the front half. This enables stationary bi-directional generation without additional moving parts or complex rotational devices or schemes.

An electrical generating unit may be connected to the turbines in any number of ways. For example, a generator may be placed on top of the device to allow for easy installation and access for maintenance if necessary. To allow for both turbines to contribute to the rotation of the generating unit, gears, belts, or other rotational motion converters may be mounted to the shafts of the turbines that extrude from the top of the enclosure. This enables a lighter device and efficient gearing for the generator.

In some embodiments, a cowl may be attached at one or both ends of the enclosure. The cowl, among other things, captures more fluid than the device would otherwise capture and increases the pressure and velocity of the fluid entering the device. The inclusion of the cowl may also enable higher device efficiency and more energy produced per unit. In some embodiments, a cowl may be attached at both ends to allow for the stationary unit to capture both the ebb and inward flows of the tide and have the benefit of a larger area of fluid captured by the device in either direction.

The mounting apparatus for the device may preferably be very flexible to allow for installation in a broader range of energy or electricity producing sites. In some embodiments, the mounting apparatus may be grid like, allowing for the grid to be added on after initial installation or to be sized down after initial environmental evaluations. In some embodiments, the mounting apparatus may be configured so several grids are able to be connected together. This apparatus may also allow for smaller individual units to be part of a larger grid. This means that large, expensive single units are not required, but many smaller units may comprise a single grid that would otherwise be occupied by a large single unit.

These smaller units allow, among other things, easy access to extract and repair or replace specific units without shutting down the entire production site. A monitoring system may also be installed to monitor each individual unit's power output allowing for easy diagnosis and maintenance.

### BRIEF DESCRIPTION OF THE DRAWINGS

FIG. 1 shows the interior of an embodiment of the fluidkinetic energy conversion enclosure.

FIG. 2 shows the fluid inlet of an embodiment of the fluidkinetic energy conversion enclosure.

FIG. 3 shows the interior of another embodiment of the fluidkinetic energy conversion enclosure.

FIG. 4 shows a skewed profile view of an embodiment of the fluidkinetic energy conversion enclosure.

FIG. 5 shows a profile view of an embodiment of the fluidkinetic energy conversion enclosure complete with a generator casing.

FIG. 6a shows a skewed view of an embodiment of an array of fluidkinetic energy conversion enclosures.

FIG. 6b shows a skewed view of an embodiment of a two-dimensional array, or grid, of fluidkinetic conversion enclosures.

Like reference numbers and designations in the various drawings indicate like elements.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

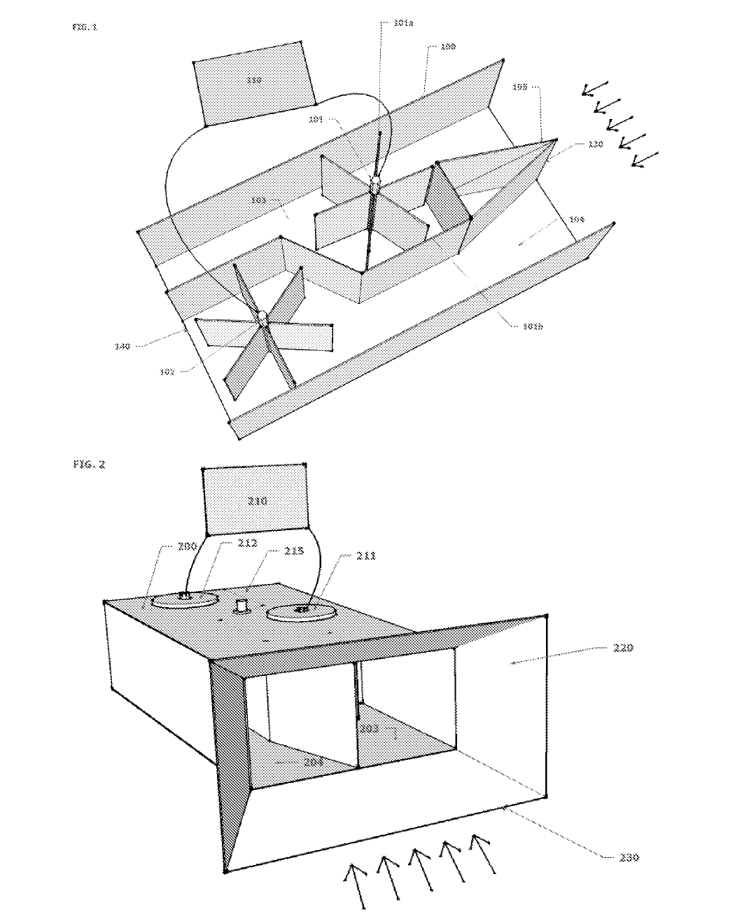

FIG. 1 shows one embodiment of the fluidkinetic energy converter. Fluidkinetic energy converter apparatus enclosure 100, is shown from above. This view shows the enclosure subdivided into two passageways 103 and 104, each passageway creating fluid communication between fluid inlet 130 and fluid outlet 140. As is demonstrated in this figure by way of multiple parallel arrows approaching inlet 130, this embodiment is designed to accept fluid at inlet 130. As the fluid enters inlet 130, it encounters an interior structure or fluid flow divider 105. The purpose of the divider 105 at the inlet is to focus and concentrate the fluid flow into a given flow path in a subsection of the passageway. This can be accomplished by dividers of numerous variety of shapes and sizes, one of which may be as shown in this embodiment as an elongated isosceles triangle shape for divider 105.

Looking first at the fluid flow paths in passageway 103 of FIG. 1, the fluid, after being redirected by divider 105, comes into contact with the working portion 101a of turbine 101. It can be seen that one of the purposes of divider 105 is to divert fluid away from the returning portion 101b of turbine 101 that, if impacted by the fluid, would hinder its ability to freely rotate about its axis of rotation. As the fluid comes into contact with turbine 101 in this configuration, it induces rotation in a counter-clockwise orientation. Were diverter 105 not in place, the fluid flow would impact not only the working portion 101a of turbine 101, but it would also impact the returning portion 101b. The fluid in contact with the working portion 101a of 101 would attempt to induce counter-clockwise rotation while the fluid in contact with the returning portion 101b of 101 would attempt to induce clockwise rotation. The combined forces would largely cancel each other out and lead to a highly inefficient turbine arrangement. Therefore, the divider 105 may be preferentially positioned to be such as to focus the fluid flow on a working portion 101a of turbine 101. Generally speaking, the minimum width of the passageways 103 and 104 and the radius of the respective turbines 101 and 102 may be optimized to accommodate the anticipated fluid flow.

Returning to FIG. 1, after fluid passes by turbine 101, it continues through passageway 103 and exits the enclosure at fluid outlet 140. Fluid flow through passageway 104 works in the same manner as discussed for passageway 103. One difference in passageway 104 is that turbine 102 may be offset and located further back from the inlet 130. In this embodiment, this offset arrangement allows for two turbines, 101 and 102, to be aligned substantially in series, meaning that they are in the fluid flow path in a sequential or one-after-the-other, as opposed to parallel, arrangement, and therefore decrease the overall width of the enclosure unit. Similar embodiments could potentially allow for more than two turbines being arranged in series all while maintaining a relatively modest overall enclosure width. Likewise, a vertical, or top-and-bottom, and other arrangements of turbines 101 and 102 can also be configured. Another difference with passageway 104 and turbine 102 as shown is that fluid passing through passageway 104 induces turbine 102 to rotate in the opposite rotational direction as turbine 101. Of course, gearing, or other converters, can be implemented to drive a generator 110 (shown connected to turbines 101 and 102 by solid lines representing the wide range of connection possibilities) in a single direction of rotation. FIG. 2 shows the embodiment of FIG. 1 from in front of the fluid inlet 230. FIG. 2 also includes a cowl 220 which may be included on some embodiments to catch and redirect a larger volume of fluid into passageways 203 and 204 and through the enclosure 200. Other fluid capture devices may also be used. Gears 211 and 212 may be attached to the rotational axes of turbines 101 and 102 (not shown). Other motion translators may also be used. Generator attachment 215 may also be located adjacent to gears 211 and 212. As fluid induces rotation of turbines 101 and 102, gears 211 and 212 also rotate. The gears 211 and 212 may be attached to a generator 210 (shown connected to gears 211 and 212 through solid lines representing the wide range of connection possibilities) that translates the gear rotation into electricity or other useful work output.

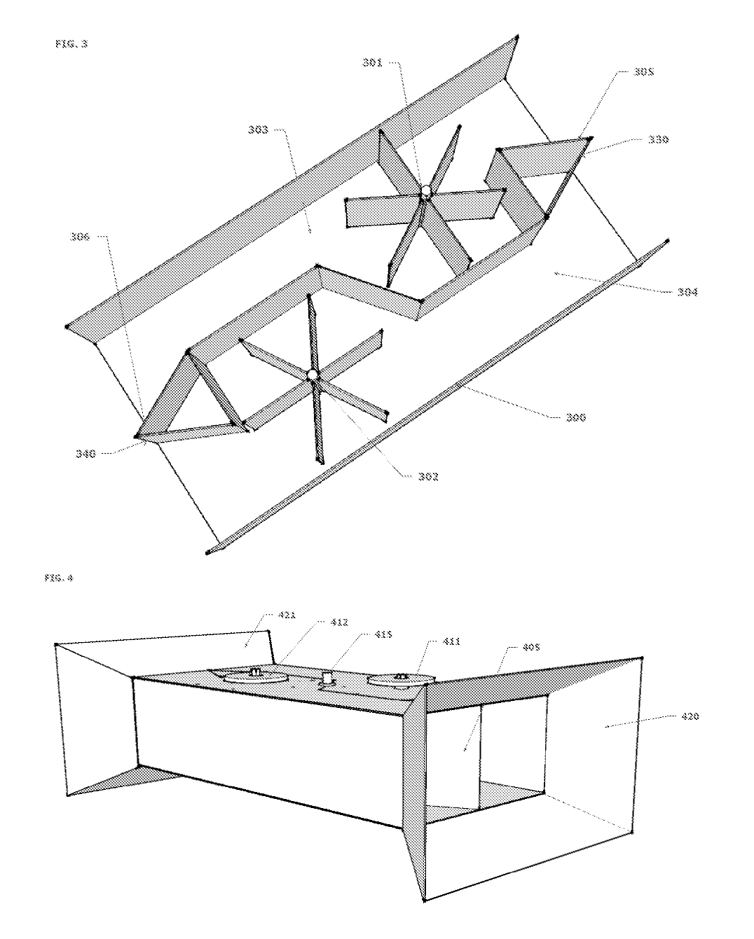

FIG. 3 is another embodiment of the fluidkinetic energy conversion enclosure 300. In this embodiment, the passageways 303 and 304 are configured with dividers 305 and 306 to enable the turbines to accept bi-directional fluid flow. In this embodiment, either end of enclosure 300 serves as an inlet or outlet. Each opening 330 and 340 may be configured to divert and focus fluid onto working portions of turbines 301 and 302. This embodiment may be advantageously located, for instance, in a tidal environment where the currents ebb and flow.

For example, as current enters opening 330, it meets divider 305 and is focused into passageways 303 and 304, respectively. As shown, the fluid in passageway 303 induces counter-clockwise rotation of turbine 301, and then continues through passageway 303 eventually exiting the enclosure through opening 340. Also as shown, the fluid in passageway 304 travels through the passageway and induces clockwise rotation of turbine 302 before exiting the enclosure at opening 340. Then, when the tide reverses direction, fluid enters the enclosure through opening 340, meets divider 306, and is focused into passageways 303 and 304. For this flow direction, the fluid in passageway 304 induces counter-clockwise rotation of the turbine 302 and then continues through the passageway 304 and exits the enclosure through opening 330. The fluid continues in passageway 303, travels the length of the passageway, induces clockwise rotation of turbine 301 and then exits the enclosure at opening 330. In a tidal environment, the constant ebb and flow of the ocean currents would constantly induce turbine rotation that would be translated into energy, such as electricity, through a generator unit. Again, suitable gearing or other motion translators can be implemented to drive an electrical generator or other output.

FIG. 4 shows a skewed profile view of the tidal embodiment of FIG. 3. As in the preceding embodiment, this one includes cowl 420. In a tidal operation it may be advantageous to include a second cowl 421. The current embodiment may implement gears 411 and 412 or other similar rotational motor converter in much the same fashion as the embodiment in FIG. 2. Also seen in FIG. 4 are the generator attachment 415 and the divider 405.

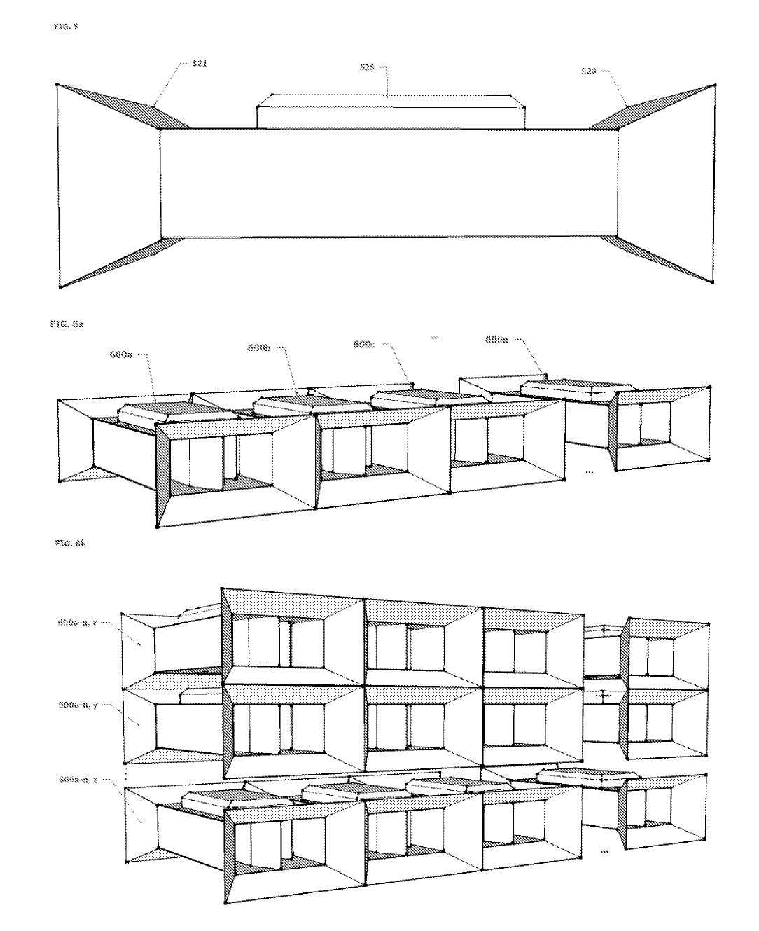

FIG. 5 shows a profile view of a dual cowl, 520 and 521, embodiment. This figure also shows the addition of a generator cover 525 which encloses the motion translators (e.g., gears 411 and 412) and the generator unit. Other protective covers may also be implemented.

FIG. 6a shows a skewed profile view of an array of generator apparatuses, 600a, 600b, 600c, . . . 600n, according to one possible embodiment. As understood by those of ordinary skill in the art, other one, two, and three dimensional array or grid arrangements, such as the grid in FIG. 6b, are also possible.

FIG. 6b shows a possible two dimensional or grid embodiment created by stacking multiple one dimensional arrays, 600a-n,x, 600a-n,y, and 600a-n,z, of generator apparatuses upon each other.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. An apparatus for converting fluid kinetic energy, the apparatus comprising:
a fluid flow divider positioned along a first axis that is substantially parallel to the predominant direction of fluid flow, and having a second axis that is substantially perpendicular to the first axis, and wherein the fluid flow divider is positioned to divide an incoming fluid flow into two fluid flow paths;
a first turbine, having a working portion and a returning portion, and positioned in one of the two fluid flow paths so that it is substantially on one side of the first axis and substantially one side of the second axis;
a second turbine, having a working portion and a returning portion, and positioned in the other of the two fluid flow paths so that it is substantially on the opposite sides of the first and second axes from the first turbine; and
wherein the fluid flow divider is arranged to direct fluid flow onto the working portion of the first turbine and the working portion of the second turbine.

2. The apparatus of claim 1, wherein the first and second turbines are configured to rotate in opposite rotational directions with respect to one another.

3. The apparatus of claim 2, further comprising a motion translator to translate the opposite rotational directions of the first and second turbines into a single direction.

4. The apparatus of claim 3 wherein the motion translator further comprises gearing.

5. The apparatus of claim 4 further comprising an electrical generator operatively connected to the gearing.

6. The apparatus of claim 1, further comprising an enclosure to substantially house the first and second turbines and the fluid flow divider.

7. The apparatus of claim 6, further comprising a generator mount on an outer surface of the enclosure.

8. The apparatus of claim 1 further comprising a cowl positioned to direct additional fluid into the two fluid flow paths.

9. The apparatus of claim 1 further comprising an electrical generator operatively driven by the at least one of the first and second turbines.

10. An apparatus for generating electric energy comprising:
a fluid inlet and a fluid outlet;
a plurality of interior passageways, each passageway in fluid communication with the fluid inlet and the fluid outlet;
each passageway being isolated from the others by at least one interior divider;
at least one turbine arranged in each interior passageway;
the at least one interior divider being arranged at the fluid inlet so as to gradually reduce the width of at least one passageway to no more than the radius of the turbine in the at least one passageway; and
an electric generator unit operatively attached to the at least one turbine.

11. The apparatus of claim 10, wherein the plurality of turbines are substantially in series.

12. The apparatus of claim 10, wherein the plurality of turbines are configured to rotate in two directions around their respective axes of rotation.

13. The apparatus of claim 10, wherein when fluid enters the enclosure fluid inlet, at least one turbine rotates in a direction opposite to that of at least a second turbine.

14. The apparatus of claim 10, wherein the at least one interior divider is also arranged at the enclosure's fluid outlet so as to gradually reduce the width of at least one passageway to no more than the radius of the turbine in the at least one passageway.

15. A method for converting kinetic energy due to fluid flow, the method comprising:
providing a plurality of passageways arranged inside an enclosure;
providing a plurality of turbines arranged within the plurality of passageways, the relationship of turbines to passageways being at least 1:1;
the enclosure further comprising a fluid inlet and a fluid outlet, the plurality of passageways arranged so as to create fluid communication between the fluid inlet and the fluid outlet;
at least one internal divider separating the plurality of passageways from each other; and
the plurality of passageways having a portion with a width of no more than the radius of the turbine in each respective passageway;
converting the kinetic energy of fluid flow through the plurality of passageways into rotational motion of the plurality of turbines; and
using the rotational motion of the plurality of turbines to drive an electric generator.

16. The method of claim 15, wherein the enclosure is located in a tidal environment, and the plurality of turbines rotate in two directions around each respective axis of rotation.

17. The method claim of 15, wherein converting the kinetic energy of fluid flow through the plurality of passageways into rotational motion of the plurality of turbines further comprises rotating at least one turbine in a direction opposite to that of at least a second turbine.

18. The method claim of 15, further comprising using an array of enclosures operatively coupled together to drive a plurality of electric generators.
